(19) United States
(12) Patent Application Publication
(10) Pub. No.: US 2009/0048380 A1
(43) Pub. Date: Feb. 19, 2009

(54) Particles modified by copolymers of olefinically unsaturated monomers

(75) Inventors: David-Christopher Glende, Bovenden (DE); Ferdinand Hardinghaus, Bad Honnef (DE); Jai-Won Park, Gottingen (DE); Karl Kohler, Diekholzen (DE)

Correspondence Address: Solvay;c/o B. Ortego - IAM-NAFTA, 3333 Richmond Avenue, Houston, TX, 77098-3099, US

(73) Assignee: SOLVAY INFRA BAD HOENNINGEN GMBH, Hannover (DE)

(21) Appl. No.: 12/282,234

(22) PCT Filed: Mar. 22, 2007
(86) PCT No.: PCT/EP07/52764

§ 371 Date: Sep. 9, 2008

(30) Foreign Application Priority Data
Mar. 24, 2006 (EP) 06006062.1

(51) Int. Cl. C09D 133/06; C08K 3/30

(52) U.S. Cl. 524/423; 524/556

(57) ABSTRACT

Particles, especially nanoparticles, being coated with copolymers (A) of olefinically unsaturated monomers (a), preparable by single-stage or multistage controlled free-radical copolymerization in an aqueous medium of (a1) at least one olefinically unsaturated monomer containing at least one chelate-forming group and (a2) at least one olefinically unsaturated monomer different from olefinically unsaturated monomer (a1) and selected from the group consisting of
(a21) monomers of the general formula (I): R¹R²C═CR³R⁴, in which the radicals R¹, R², R³, and R⁴ each independently are hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of the variables R¹, R², R³ and R⁴ are substituted or unsubstituted aryl, arylalkyl or arylcycloalkyl radicals, especially substituted or unsubstituted aryl radicals,
(a22) olefinically unsaturated terpene hydrocarbons, and
(a23) dimeric alpha-alkylvinylaromatics.
   They are suitable as a polyether filler, for adhesives as well.

### FIELD OF THE INVENTION

The present invention relates to particles modified by new copolymers of olefinically unsaturated monomers, preferably nanoparticles, especially barium sulphate modified accordingly, and also to the use of the particles, particularly the nanoparticles.

### PRIOR ART

Copolymers of olefinically unsaturated monomers that are preparable by controlled single-stage or multistage free-radical copolymerization of
at least one first olefinically unsaturated monomer and
at least one second olefinically unsaturated monomer, which is different from the first olefinically unsaturated monomer and has the general formula I

R¹R²C═CR³R⁴ (I)
in which the radicals R¹, R², R³, and R⁴ each independently are hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of the variables R¹, R², R³, and R⁴ are substituted or unsubstituted aryl, arylalkyl or arylcycloalkyl radicals, especially substituted or unsubstituted aryl radicals,
   in an aqueous medium are known from German patent application DE 101 26 651 A1. They are used as emulsifiers in the preparation of pigmented powder coating suspensions (powder slurries). They are preferably introduced via pigment pastes or pigment preparations into the aqueous media of the powder coating suspensions. The pigment pastes or pigment preparations may have a particularly high level of nanoparticles, especially hydrophilic oxidic nanoparticles based on silica, alumina, zinc oxide, zirconium oxide, and the polyacids and heteropolyacids of transition metals, preferably of molybdenum and tungsten. The nanoparticles have a primary particle size <50 nm.

Whether these known copolymers are able to act as crystallization inhibitors and especially dispersants with respect to particles, preferably nanoparticles; especially with respect to barium sulphate particles, particularly barium sulphate nanoparticles, particularly in order to stabilize primary barium sulphate particles, is not apparent from the German patent application.

### Problem Addressed by the Invention

The object on which the present invention was based was that of providing new particles, preferably new nanoparticles, especially new barium sulphate particles, particularly new barium sulphate nanoparticles, which are chemically modified, the chemical modification being brought by copolymerized crystallization inhibitors and/or dispersants which are preparable by the controlled free-radical copolymerization of olefinically unsaturated monomers.

A further object of the present invention was to find a new process for producing nanoparticles thus modified.

### Solution Provided by the Invention

Found accordingly have been particles, preferably nanoparticles, comprising copolymers (A) of olefinically unsaturated monomers (a), as a crystallization inhibitor and/or preferably as a dispersant, the copolymers being preparable by single-stage or multistage controlled free-radical copolymerization in an aqueous medium of
(a1) at least one olefinically unsaturated monomer containing at least one chelate-forming group and
(a2) at least one olefinically unsaturated monomer different from olefinically unsaturated monomer (a1) and selected from the group consisting of
   (a21) monomers of the general formula I

R¹R²C═CR³R⁴ (I)
in which the radicals R¹, R², R³ and R⁴ each independently are hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of the variables R¹, R², R³ and R⁴ are substituted or unsubstituted aryl, arylalkyl or arylcycloalkyl radicals, especially substituted or unsubstituted aryl radicals;
(a22) olefinically unsaturated terpene hydrocarbons, and
(a23) dimeric alpha-alkylvinylaromatics.

The above-identified copolymers (A) of olefinically unsaturated monomers (a) are referred to below as “copolymers (A)”.

Copolymers (A) can be prepared by subjecting
(a1) at least one olefinically unsaturated monomer containing at least one chelate-forming group and
(a2) at least one olefinically unsaturated monomer different from olefinically unsaturated monomer (a1) and selected from the group consisting of
   (a21) monomers of the general formula I

R¹R²C═CR³R⁴ (I)
in which the radicals R¹, R², R³ and R⁴ each independently are hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of the variables R¹, R², R³ and R⁴ are substituted or unsubstituted aryl, arylalkyl or arylcycloalkyl radicals, especially substituted or unsubstituted aryl radicals;
(a22) olefinically unsaturated terpene hydrocarbons, and
(a23) dimeric alpha-alkylvinylaromatics;

to controlled free-radical copolymerization in an aqueous medium.

### ADVANTAGES OF THE INVENTION

In the light of the prior art it was surprising and unforeseeable for the skilled worker that the object on which the present invention was based could be achieved by means of the particles, especially the nanoparticles, which comprise copolymers (A) as a crystallization inhibitor and/or preferably as a dispersant.

Preference is given to barium sulphate particles, especially barium sulphate nanoparticles, which comprise the aforementioned copolymers as crystallization inhibitors and/or dispersants. One of the main advantages of the present invention is the effective stabilization of the dispersions of these primary barium sulphate particles.

It was surprisingly been found, moreover, that the preparation process of the invention for the particles, preferably the nanoparticles, was implementable particularly simply, reliably, and with very good reproducibility, and that the particles, especially the nanoparticles, can be converted into a readily redispersible powder.

The resulting new particle or nanoparticle dispersions, especially the barium sulphate dispersions, are outstandingly suitable for producing new materials curable physically, thermally, with actinic radiation, and both thermally and with actinic radiation, especially new coating materials, adhesives, and sealants, and also precursors to mouldings or films.

### DETAILED DESCRIPTION OF THE INVENTION

The copolymers (A) of olefinically unsaturated monomers (a) which are required for the preparation of the particles, especially the nanoparticles, according to the invention are preparable by subjecting at least
(a1) at least one, especially one, olefinically unsaturated monomer containing at least one, especially one, chelate-forming group and
(a2) at least one, especially one, olefinically unsaturated monomer different from olefinically unsaturated monomer (a1) and selected from the group consisting of
   (a21) monomers of the general formula I

R¹R²C═CR³R⁴ (I),
in which the radicals R¹, R², R³, and R⁴ each independently are hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of the variables R¹, R², R³, and R⁴ are substituted or unsubstituted aryl, arylalkyl or arylcycloalkyl radicals, especially substituted or unsubstituted aryl radicals,
(a22) olefinically unsaturated terpene hydrocarbons, and
(a23) dimeric alpha-alkylvinylaromatics, and also, if desired,
(a3) at least one olefinically unsaturated monomer different from the monomers (a1) and (a2)
   to controlled free-radical copolymerization in an aqueous medium.

The olefinically unsaturated monomers (a1) here contain at least one, especially one, chelate-forming group, capable of forming what are called chelates. A chelate is the cyclic structure formed when two or more electron donor atoms (or atomic groupings which act as electron donors) form coordinate bonds to a single metal atom or metal cation (see Kirk-Othmer Encyclopedia of Chemical Technology, 3^{rd} Ed., Vol. 5, p. 339-368 (1979)).

The chelate-forming group of the monomer (a1) is preferably able to bind the metal atoms or metal cations through two or more sites (namely through two or more electron donor atoms or atomic groupings which act as electron donors), in particular through two sites (namely through two electron donor atoms or atomic groupings which act as electron donor atoms). When the chelate forming group of the monomer (a1) is able to bind the metal atoms or metal cations through two sites, it is called bidentate. The chelate forming group of the monomer (a1) is thus preferably at least bidentate, in particular bidentate (see Kirk-Othmer Encyclopedia of Chemical Technology, 3^{rd} Ed., Vol. 5, p. 339-368 (1979)).

The chelate-forming group preferably contains at least two, especially two, atomic groupings which act as electron donors. Via these atomic groupings the monomers (a1) are capable of forming coordination compounds with metal atoms or metal cations.

Particular preference is given to using atomic groupings selected from the group consisting of carbonyl groups (>C═O), thiocarbonyl groups (>C═S), ether groups (—CH₂—O—CH₂—), thioether groups (—CH₂—S—CH₂—), primary, secondary, and tertiary amino groups (≧C—NR⁵₂) with R⁵=hydrogen atom or alkyl radical having 1 to 6 carbon atoms, primary and secondary imino groups (>C═NR⁵) with R⁵=hydrogen atom or alkyl radical having 1 to 6 carbon atoms, oxime groups (>C═N—O—H), imino ether groups (>C═N—O—R⁶) with R⁶=alkyl radical having 1 to 10 carbon atoms or cycloalkyl radical having 4 to 10 carbon atoms, and also primary, secondary, and tertiary phosphine groups (—PR⁷₂) with R⁷=hydrogen atom or alkyl radical having 1 to 6 carbon atoms, cycloalkyl radical having 4 to 10 carbon atoms or aryl radical having 6 to 10 carbon atoms. With very particular preference the atomic groupings are carbonyl groups (>C═O).

In particular the chelate-forming groups are 1,3-dicarbonyl groups, especially acetoacetoxy groups (CH₃—C(O)—CH₂—C(O)—O—).

The olefinically unsaturated groups of the monomers (a1) are preferably selected from the group consisting of (meth)acrylate, ethacrylate, crotonate, cinnamate, vinyl ether, vinyl ester, dicyclopentadienyl, norbornenyl, isoprenyl, isopropenyl, allyl or butenyl groups, dicyclopentadienyl ether, norbornenyl ether, isoprenyl ether, isopropenyl ether, allyl ether or butenyl ether groups, or dicyclopentadienyl ester, norbornenyl ester, isoprenyl ester, isopropenyl ester, allyl ester or butenyl ester groups.

In particular the olefinically unsaturated groups are (meth)acrylate groups.

Here and below, the term “(meth)acrylate groups” is used as an abbreviated version of “acrylate groups and/or methacrylate groups”.

In a monomer (a1) the chelate-forming group or chelate-forming groups is or are attached to the olefinically unsaturated group or olefinically unsaturated groups via at least one covalent bond or via at least one divalent, especially divalent, linking group.

Preferably in the monomer (a1) a chelate-forming group is linked to an olefinically unsaturated group via a divalent linking group.

Suitable divalent linking groups include basically all divalent organic groups which are inert.

In the context of the present invention, “inert” means that the divalent linking groups in question do not inhibit the controlled free-radical copolymerization in the preparation of the copolymers (A) and do not, before, during or after the preparation of the copolymers (A), initiate any unwanted secondary reactions, such as decomposition reactions, for example.

The divalent linking groups are preferably groups which include or are composed of alkylene groups, cycloalkylene groups and/or arylene groups. Preference is given to using alkylene groups, with particular preference alkylene groups having 2 to 6 carbon atoms, especially 1,2-ethylene groups.

Examples of especially suitable monomers (a1) are 2-(acetoacetoxy)ethyl methacrylate and acrylate, especially the methacrylate, which is sold under the brand name Lonzamon® AAEMA by Lonza.

The amount of olefinically unsaturated monomer (a1) used in the controlled free-radical copolymerization may vary very widely and can therefore be adapted outstandingly to the requirements of the case in hand. The amount of (a1), based in each case on the sum of the monomers (a1) and (a2), is preferably from 1% to 99.9%, more preferably from 2% to 99%, with particular preference from 3% to 98%, and in particular from 5% to 97% by weight.

As monomers (a2) it is possible to use monomers (a21) of the general formula I.

R¹R²C═CR³R⁴ (I),

In the general formula I, the radicals R¹, R², R³, and R⁴ each independently of one another are hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of the variables R¹, R², R³, and R⁴ are substituted or unsubstituted aryl, arylalkyl or arylcycloalkyl radicals, especially substituted or unsubstituted aryl radicals.

Examples of suitable alkyl radicals are methyl, ethyl, propyl, isopropyl, n-butyl, isobutyl, tert-butyl, amyl, hexyl or 2-ethylhexyl.

Examples of suitable cycloalkyl radicals are cyclobutyl, cyclopentyl or cyclohexyl.

Examples of suitable alkylcycloalkyl radicals are methylene cyclohexane, ethylene cyclohexane or propane-1,3-diylcyclohexane.

Examples of suitable cycloalkylalkyl radicals are 2-, 3- or 4-methyl-, -ethyl-, -propyl- or -butylcyclohex-1-yl.

Examples of suitable aryl radicals are phenyl, naphthyl or biphenylyl.

Examples of suitable alkylaryl radicals are benzyl or ethylene- or propane-1,3-diylbenzene.

Examples of suitable cycloalkylaryl radicals are 2-, 3- or 4-phenylcyclohex-1-yl.

Examples of suitable arylalkyl radicals are 2-, 3- or 4-methyl-, -ethyl-, -propyl- or -butylphen-1-yl.

Examples of suitable arylcycloalkyl radicals are 2-, 3- or 4-cyclohexylphen-1-yl.

The above-described radicals R¹, R², R³, and R⁴ may be substituted. For this purpose it is possible to use electron-withdrawing or electron-donating atoms or organic radicals.

Examples of suitable substituents are halogen atoms, especially chlorine and fluorine, nitrile groups, nitro groups, partially or fully halogenated, especially chlorinated and/or fluorinated, alkyl, cycloalkyl, alkylcycloalkyl, cycloalkylalkyl, aryl, alkylaryl, cycloalkylaryl, arylalkyl and arylcycloalkyl radicals, including those exemplified above, especially tert-butyl; aryloxy, alkyloxy, and cycloalkyloxy radicals, especially phenoxy, naphthoxy, methoxy, ethoxy, propoxy, butyloxy or cyclohexyloxy; arylthio, alkylthio, and cycloalkylthio radicals, especially phenylthio, naphthylthio, methylthio, ethylthio, propylthio, butylthio or cyclohexylthio; hydroxyl groups; and/or primary, secondary and/or tertiary amino groups, especially amino, N-methylamino, N-ethylamino, N-propylamino, N-phenylamino, N-cyclohexylamino, N,N-dimethylamino, N,N-diethylamino, N,N-dipropylamino, N,N-diphenylamino, N,N-dicyclohexylamino, N-cyclohexyl-N-methylamino or N-ethyl-N-methylamino.

Examples of monomers (a21) used with particular preference are diphenylethylene, dinaphthaleneethylene, cis or trans-stilbene, vinylidenebis(4-N,N-dimethylaminobenzene), vinylidenebis(4-aminobenzene) or vinylidenebis(4-nitrobenzene).

The monomers (a21) can be used individually or as a mixture of at least two monomers (a21).

In respect of the reaction regime and the properties of the resulting copolymers (A) very particular advantage attaches to diphenylethylene (a21), which is therefore used with very particular preference as monomer (a21) of the general formula I.

Further it is possible as monomers (a2) to use olefinically unsaturated terpene hydrocarbons (a22).

The olefinically unsaturated terpene hydrocarbons (a22) are customary and known, naturally occurring or synthetic compounds. It is preferred to use olefinically unsaturated terpene hydrocarbons containing no reactive functional groups, such as hydroxyl groups, amino groups or carbonyl groups.

The olefinically unsaturated terpene hydrocarbon (a22) is preferably selected from the group consisting of acyclic terpenes, monocyclic terpenes, bicyclic terpenes, acyclic sesquiterpenes, monocyclic sesquiterpenes, bicyclic sesquiterpenes, tricyclic sesquiterpenes, acyclic diterpenes, monocyclic diterpenes, and tricyclic diterpenes.

With particular preference the terpene hydrocarbon (a22) is selected from the group consisting of acyclic monoterpenes, monocyclic terpenes, and bicyclic terpenes. With very particular preference the terpene hydrocarbon (a22) is selected from the group consisting of ocimene, myrcene, the menthenes, the menthadienes, alpha-pinene, and beta-pinene.

In particular the menthadienes (a22) are selected from the group consisting of alpha-terpinene, beta-terpinene, gamma-terpinene, terpinolene, alpha-phellandrene, beta-phellandrene, limonene, and dipentene.

Gamma-Terpinene is used especially as monomer (a22).

As monomers (a2) it is for example possible to use dimeric alpha-alkylvinylaromatics (a23) and preferably dimeric alpha-alkylstyrenes (a23), especially dimeric alpha-methylstyrene (a23).

In the controlled free-radical copolymerization the amount of monomers (a2) used may vary widely and so can be adapted outstandingly to the requirements of the case in hand. The amount of (a2), based in each case on the sum of the monomers (a1) and (a2), is preferably from 0.1% to 99%, more preferably from 1% to 98%, with particular preference from 2% to 97%, and in particular from 3% to 95% by weight.

The above-described olefinically unsaturated monomers (a1) and (a2) may additionally be copolymerized with at least one different olefinically unsaturated monomer (a3). It is preferred to use at least two olefinically unsaturated monomers (a3).

The structure of the olefinically unsaturated monomers (a3) may vary greatly. What is essential is that the olefinically unsaturated monomers (a3) can be subjected to controlled free-radical copolymerization with the above-described olefinically unsaturated monomers (a1) and (a2) without causing any unwanted secondary reactions.

The olefinically unsaturated monomers (a3) may either contain or be free from any of a very wide variety of the functional groups. Where they do contain functional groups, these groups should not enter into any unwanted physical or chemical interactions with the chelate-forming groups of the monomers (a1) and should neither inhibit nor accelerate the controlled free-radical copolymerization. The skilled worker is therefore able to select suitable olefinically unsaturated monomers (a3) on the basis of his or her general knowledge with ease and, where appropriate, with the aid of a few rangefinding experiments.

The olefinically unsaturated monomers (a3) serve to vary the profile of properties of the copolymers (A) of the invention. On account of the multiplicity of suitable olefinically unsaturated monomers (a3) the profile of properties of the copolymers (A) can easily be given extremely broad variation and be adapted outstandingly to the requirements of the particular end use, which represents a very particular advantage of the copolymers (A).

Examples of suitable olefinically unsaturated monomers (a3) are known from German patent application DE 101 26 651 A1, pages 4 to 5, paragraphs [0024] and [0025].

Within the bounds of the process described above, the copolymers (A) are prepared by the controlled free-radical copolymerization of the above-described olefinically unsaturated monomers (a1) and (a2), and also, if desired, (a3), preferably (a1), (a2), and (a3).

The olefinically unsaturated monomers (a1), (a2), and (a3) are preferably used in amounts, based in each case on (a1), (a2), and (a3), of
from 1% to 30%, preferably from 2% to 20%, and in particular from 5% to 15% by weight of (a1),
from 0.1% to 25%, preferably from 1% to 15%, and in particular from 2% to 10% by weight of (a2), and
from 45% to 98.9%, preferably from 65% to 97%, and in particular from 75% to 93% by weight of (a3).

The monomers (a1), (a2), and, if desired, (a3) are reacted with one another in the presence of at least one free-radical initiator to give the copolymer (A). Examples of initiators that can be used include the following: dialkyl peroxides, such as di-tert-butyl peroxide or dicumyl peroxide; hydroperoxides, such as cumene hydroperoxide or tert-butyl hydroperoxide; peresters, such as tert-butyl perbenzoate, tert-butyl perpivalate, tert-butyl per-3,5,5-trimethylhexanoate or tert-butyl per-2-ethylhexanoate; potassium, sodium or ammonium peroxodisulphate; azo dinitriles such as azobisisobutyronitrile; C-C-cleaving initiators such as benzpinacol silyl ethers; or a combination of a nonoxidizing initiator with hydrogen peroxide.

It is preferred to add comparatively large amounts of free-radical initiator, the proportion of the initiator in the reaction mixture, based in each case on the total amount of the monomers (a1), (a2), and, if desired, (a3) and of the initiator, being preferably from 0.5% to 50%, with particular preference from 1% to 20%, and in particular from 2% to 15% by weight.

The weight ratio of initiator to the monomers (a2) is preferably from 4:1 to 1:4, with particular preference from 3:1 to 1:3, and in particular from 2:1 to 1:2. Further advantages result if the initiator is used in excess within the stated limits.

The free-radical copolymerization is preferably carried out in customary and known apparatus, especially stirred tanks, tube reactors or Taylor reactors, the Taylor reactors being designed such that the conditions of Taylor flow are met over the entire length of the reactor, even if as a result of the copolymerization there is a sharp change—in particular an increase—in the kinematic viscosity of the reaction medium.

The copolymerization is carried out in an aqueous medium.

The aqueous medium substantially comprises water. The aqueous medium here may include, in minor amounts, organic solvents and/or other dissolved solid, liquid or gaseous, organic and/or inorganic compounds of low and/or high molecular mass, provided that these compounds do not adversely affect, or even inhibit, the copolymerization. In the context of the present invention the term “minor amount” refers to an amount which does remove the aqueous character of the aqueous medium. The aqueous medium, however, may also be water alone.

The copolymerization is preferably carried out in the presence of at least one base. Particular preference is given to bases of low molecular mass, such as sodium hydroxide solution, potassium hydroxide solution, ammonia, diethanolamine, triethanolamine, mono-, di-, and triethylamine, and/or dimethylethanolamine, especially ammonia and/or di- and/or triethanolamine.

The copolymerization is advantageously carried out at temperatures above room temperature and below the lowest decomposition temperature of the respective monomers (a1), (a2), and, if desired, (a3), used, the temperature range selected being preferably from 10 to 150° C., with very particular preference from 70 to 120° C., and in particular from 80 to 110° C.

When particularly volatile monomers (a1), (a2), and, if desired, (a3) are used it is also possible to carry out the copolymerization under superatmospheric pressure, preferably under from 1.5 to 3000 bar, more preferably from 5 to 1500 bar, and in particular from 10 to 1000 bar.

With regard to number-average and mass-average molecular weights Mₙ and M_{w} and also the molecular weight distribution M_{w}/Mₙ there are no restrictions whatsoever imposed on the copolymers (A).

Advantageously, however, the copolymerization is performed in such a way so as to result in a molecular weight distribution M_{w}/Mₙ, as measured by gel permeation chromatography using polystyrene as standard, of ≦4, preferably ≦2, and in particular ≦1.5, and also, in certain cases, ≦1.3.

The molecular weights Mₙ and M_{w} of the copolymers (A) can be controlled within wide limits through the selection of the ratio of monomer (a1), (a2), and, if desired, (a3) to free-radical initiator. In this context the amount of monomer (a2), in particular, determines the molecular weight, specifically such that the greater the fraction of monomer (a2), the lower the molecular weight obtained.

Preferably the number-average molecular weight Mₙ is from 1000 to 100 000 daltons, more preferably from 1500 to 50 000 daltons, and in particular from 2000 to 25 000 daltons.

In the process for preparing the copolymers (A) they are obtained in the form of fine dispersions, referred to below as “dispersions (A)”. The particle size of the dispersions (A) may vary widely. Their average particle size d₅₀ as determined by photon correlation spectroscopy or laser diffraction is preferably from 1 nm to 500 μm.

The dispersions (A) can be used as they are. However, the copolymers (A) can be isolated from them by means of customary and known methods, such as freeze drying, for example, and can be used in the form of liquid or solid resins (A). The form in which the copolymers (A) are used is guided by the requirements of the case in hand.

The copolymers (A) and the dispersions (A) are used as crystallization inhibitors and/or dispersants for particles, preferably nanoparticles, particularly in the context of the preparation of the dispersions of nanoparticles.

The term “particles” identifies in the context of the present invention solid compounds with a primary particle size of less than or equal to 200 μm, preferably of less than or equal to 100 μm, more preferably of less than or equal to 50 μm, and very preferably of less than or equal to 20 μm. With still more preference the primary particle size is of less than or equal to 10 μm, in particular of less than or equal to 5 μm, especially of less than or equal to 1 μm.

The particles are preferably selected from the group consisting of metals, compounds of metals, and organic compounds, especially compounds of metals.

The metals are preferably selected from the group consisting of ruthenium, osmium, cobalt, rhodium, iridium, nickel, palladium, platinum, silver, and gold.

The metal compounds are preferably selected from the compounds of metals of main groups one to five, of transition groups three to six and also of transition groups one and two of the Periodic Table of the Elements, and also the lanthanides. More preferably, the compounds of metals are selected from the group consisting of magnesium, calcium, strontium, barium, boron, aluminium, gallium, silicon, germanium, tin, lead, arsenic, antimony, copper, silver, gold, zinc, indium, titanium, zirconium, hafnium, vanadium, niobium, tantalum, molybdenum, chromium, tungsten, and cerium. Barium or strontium is used in particular.

The compounds of the metals are preferably oxides, oxide hydrates, sulphates, carbonates, hydroxides, fluorides, oxyfluorides or phosphates, including compounds having two or more of these anions, such as oxifluorides, and also hydrates of salts and mixtures thereof. The compounds of the metals are especially sulphates. Particles which can be used are all customary and known particles.

Specific nanoparticles which are good to use are selected from the group consisting of BaSO₄, SrSO₄, MgCO₃, CaCO₃, BaCO₃, SrCO₃, Zn₃(PO₄)₂, Ca₃(PO₄)₂, Sr₃(PO₄)₂, Ba₃(PO₄)₂, Mg₂(PO₄)₂, SiO₂, Al₂O₃, MgF₂, CaF₂, BaF₂, SrF₂, TiO₂, ZrO₂, fluorides and oxifluorides of lanthanide metals, and also alkali metal fluorometallates and alkaline earth metal fluorometallates and mixtures thereof, such as BaSO₄/CaCO₃ mixture. An example of mixed salt is BaTiO₃.

The particles may be of natural origin. For example, barium sulphate may be natural barite. Than particles may be dry-ground or ground in suspension beforehand. Synthetic particles, especially synthetic nanoparticles, are preferred. Precipitated particles, especially precipitated nanoparticles, are more preferred. For example, barium sulphate may be obtained by precipitation starting from various sources of barium ions and sulphate ions. The precipitation may be performed starting from solutions, suspensions or emulsions containing one or more precursors of the barium and sulphate ions. For example, barium sulphate can be precipitated by reacting barium chloride solution, barium hydroxide solution or the solution obtained when extracting barium sulphide from the reduction of barium sulphate with a solution of alkali metal sulphate or sulphuric acid.

In particular the copolymers are used for the chemical modification of barium carbonate particles, strontium carbonate particles, and especially barium sulphate particles. By way of example it is possible to coat Blanc Fixe (precipitated barium sulphate) in this way.

One preferred embodiment of the present invention relates to nanoparticles. In the context of the present invention the term “nanoparticles” identifies particles of the type designated above which have a primary particle size of less than or equal to 500 nm. The modified nanoparticles preferably have an average primary particle size of less than or equal to 400 nm, more preferably less than or equal to 100 nm, with particular preference less than or equal to 50 nm. Advantageously, the modified nanoparticles have an average primary particle size from 5 to 50 nm, in particular from 10 to 30 nm.

It is known that certain inorganic particles, in the course of their conventional preparation (precipitation), can form agglomerates (secondary particles) made up of primary particles. The nanoparticles of the invention may contain agglomerates (secondary particles) having a size of less than or equal to 1000 nm. Preferably, 90% or more of all the particles (agglomerated secondary particles and unagglomerated primary particles) have a size of less than or equal to 500 nm, preferably less than or equal to 400 nm, more preferably less than or equal to 250 nm, in particular less than or equal to 100 nm, more preferably less than or equal to 80 nm; more preferably still, 90% or more of all the particles have a size less than or equal to 50 nm, and even less than or equal to 30 nm.

The size of the particles (secondary particles and non agglomerated primary particles, without differentiation between the agglomerated secondary particles and the unagglomerated primary particles) can be measured by various techniques, like for instance Dynamic Light Scattering (DLS) technique (standard ISO-DIS 22412, 2006), or Centrifugal Liquid Sedimentation method (standard ISO 13318-2, 2001). Such methods lead to various informations, such as the particle size distribution, the maximal particle size and the average particle size. These methods allow consequently to measure the maximal size of the secondary particles.

When analysed by the Dynamic Light Scattering (DLS) technique (standard ISO-DIS 22412, 2006), the nanoparticles of the invention have a size of less than or equal to 1000 nm. Preferably, 90% or more of all the particles (agglomerated secondary particles and unagglomerated primary particles) have a size of less than or equal to 500 nm, preferably less than or equal to 400 nm, more preferably less than or equal to 250 nm, in particular less than or equal to 100 nm, more preferably less than or equal to 80 nm; more preferably still, 90% or more of all the particles have a size less than or equal to 50 nm, and even less than or equal to 30 nm.

When analysed by the Centrifugal Liquid Sedimentation method (standard ISO 13318-2, 2001), the nanoparticles of the invention have a size of less than or equal to 1000 nm. Preferably, 90% or more of all the particles (agglomerated secondary particles and unagglomerated primary particles) have a size of less than or equal to 500 nm, preferably less than or equal to 400 nm, more preferably less than or equal to 250 nm, in particular less than or equal to 100 nm, more preferably less than or equal to 80 nm; more preferably still, 90% or more of all the particles have a size less than or equal to 50 nm, and even less than or equal to 30 nm.

The average primary particle size of the nanoparticles according to the invention can be measured by X-ray diffraction (XRD line broadening) technique. When analysed by X-ray diffraction technique, the nanoparticles of the invention have an average primary particle size of less than or equal to 500 nm, preferably less than or equal to 400 nm, more preferably less than or equal to 100 nm, with very particular preference less than or equal to 50 nm, especially less than or equal to 30 nm. A frequently observed, production-related lower limit on the primary particle size is 5 nm, for example, but may also be lower. Advantageously, the modified nanoparticles have an average primary particle size of from 5 to 50 nm, in particular of from 10 to 30 nm. The nanoparticles are partly or even substantially completely in the form of unagglomerated primary particles.

With very particular advantage the copolymers (A) and their dispersions (A) are used as crystallization inhibitors and especially as dispersants in the preparation of deagglomerated barium sulphate nanoparticles, as described analogously in, for example, German patent application DE 102004010201 A1, page 6 paragraph [0043] to page 7 paragraph [0050], the content of which is incorporated herein by reference. “Deagglomerated” means that the average secondary particle size is not more than 30% greater than the average primary particle size.

To prepare the copolymer-coated particles the two starting components are contacted with one another in aqueous solution or in an organic solvent. If desired it is possible in this case for comminution to take place. Contacting may take place for example in mills, such as in a bead mill, for example.

To prepare the preferred particles, namely nanoparticles, corresponding starting materials are contacted. The procedure is guided by the nature of the starting material.

Starting material is used which is already in the form of nanoparticles. Depending on the chemical composition and nature of the preparation, the starting material may be in the form of secondary particles (agglomerates), which can be far larger than the primary particles themselves. If there are no agglomerates present, it is sufficient to coat this starting material with the above-described dispersant. This can be done by contacting the starting material with the aqueous dispersion of the dispersant, in a stirred vessel for example; instead of water it is also possible to use organic solvents such as alcohols, ethers, esters or halogenated (hydro)carbon compounds. If desired it is possible to use dissolvers in order to bring about intimate contact of the particles with the copolymer.

It is also possible to coat, with the dispersant, nanoparticles which, although in the form of nanoscale particles, are nevertheless agglomerated. Barium sulphate, for example, is obtained on precipitation in the form of nanoscale particles, but these particles undergo very substantial agglomeration; the agglomerates formed on drying are very hard and are difficult to deagglomerate mechanically. These agglomerates must be deagglomerated if the aim is to prepare coated particles which are to be nanoscale in terms both of the primary particles and of the secondary particles. The deagglomeration of the secondary particles can take place prior to coating with the dispersant. It is preferred, however, to perform deagglomeration of the secondary particles, and their coating, simultaneously, since in this case intense contact of the starting materials is ensured.

The preparation of the modified nanoparticles is elucidated in greater detail below.

In a first embodiment, the particles, for example particles of barium sulphate, are precipitated without the addition of a crystallization inhibitor. The particles prepared in this way are mixed thoroughly, as described later on below, with the dispersion of the copolymers (A) in water or an organic solvent, and in the course of this mixing the agglomerates formed are deagglomerated, in a dissolver for example, and then a ball mill. This gives particles which are coated with the dispersant and contain no crystallization inhibitor. Comminution is continued until the desired degree of fineness is reached.

In a second embodiment, the particles, for instance particles of barium sulphate, are precipitated in the presence of a crystallization inhibitor. This second embodiment is used for further elucidation of the invention.

This second embodiment is based on the preparation of chemically modified nanoparticles as described in international patent application PCT/EP2006/062860. As far as barium sulphate is concerned, its preparation is described in detail in WO 05/054133. The texts of those two applications are incorporated herein by reference.

By way of example, the nanoparticles can be prepared by precipitation in the presence of crystallization inhibitors such as those specified in PCT/EP2006/062860 and in WO 2005/054133. It is particularly preferred to precipitate the nanoparticles in the presence of at least one crystallization inhibitor such as a polyacrylate, for example Dispex® N40 (from CIBA), or citrate. The copolymers (A) may likewise be used as crystallization inhibitor.

As already mentioned, in the course of precipitation, the nanoscale primary particles typically form relatively large agglomerates (secondary particles), which can be deagglomerated only with difficulty and can then readily form again.

Thus, in a second step, the copolymers (A) are incorporated, by means for example of intimate deagglomeration in a comminution apparatus in the presence of copolymers (A). The mixture of nanoparticles and aqueous copolymers (A) dispersion is therefore mixed thoroughly, and, in the course of this mixing, the secondary particles present are largely comminuted. For this purpose, the aqueous mixture (or the mixture in an organic solvent if such a solvent has been used) comprising the copolymers (A), the inorganic particles and water, is passed through an appropriate comminution apparatus. It has been found to be advantageous first to pass the mixture through a dissolver and then through a mill. Ball mills, for example, are highly suitable. Comminution is carried out until the desired degree of fineness is reached. The secondary particles are predominantly deagglomerated, and a dispersion of deagglomerated nanoparticles coated with the copolymer is formed.

Alternatively, the precipitation itself can take place in the presence of copolymers (A) and, if desired, an additional treatment may follow, again in a suitable comminution apparatus such as a ball mill, for example a bead mill, possibly in the presence of copolymers (A) again.

The deagglomerated nanoparticles of the invention, whether prepared with or without crystallization inhibitor, can be isolated from their dispersions by removal of the water (or any other solvents used) and stored and transported without problems prior to their further use. Such a drying operation can be conducted, for example, by means of spray drying. In this context it proves to be a very particular advantage of the deagglomerated nanoparticles of the invention, especially the barium sulphate nanoparticles, that, although they form a kind of agglomerates when the water and/or organic solvent used is separated off, these agglomerates, on account of the presence therein of copolymers (A), can be redeagglomerated and redispersed easily in water and/or organic solvents. Nanoparticles of this kind coated with dispersant, in the form of a redispersible, deagglomerated solid, as obtainable in the process described above, are likewise provided by the invention. The solid is preferably in the form of a powder.

The nanoparticle content of the mixture made up of the deagglomerated nanoparticles and the copolymers (A) is usually at least 10%, preferably at least 20%, more preferably at least 40%, in particular at least 50%. The nanoparticle content of the mixture made up of the deagglomerated nanoparticles and the copolymers (A) is generally at most 90%, advantageously at most 85%, in most cases at most 80% by weight. Suitable ranges for the nanoparticle content of the mixture made up of the deagglomerated nanoparticles and the copolymers (A) is for instance from 10 to 90%, in particular from 20% to 80% by weight. The amount of copolymers (A) therein is usually from 90% to 10%, preferably from 80% to 20% by weight, based on the mixture. Nanoparticle dispersions having a particularly high nanoparticle content of around 70% by weight, based on the dispersion, can for example be prepared.

The above-described nanoparticles of the invention comprising the copolymers (A) may be used, particularly in the form of their dispersions or as isolated nanoparticles, generally as fillers for polymers, for example, for producing materials curable physically, thermally, with actinic radiation, and both thermally and with actinic radiation.

For the purposes of the present invention actinic radiation means electromagnetic radiation such as near infrared (NIR), visible light, UV radiation, X-rays or gamma radiation, especially UV radiation, and particulate radiation such as electron beams, beta radiation, alpha radiation, proton beams, and neutron beams, especially electron beams.

The curable materials are outstandingly suitable for producing thermoplastic and thermoset materials.

The curable materials are used preferably as coating materials, adhesives, sealants, and also as precursors to mouldings and films, for producing coatings, adhesive layers, seals, mouldings, and films; for example, for producing highly scratch-resistant, pigmented and unpigmented surface coatings, more preferably transparent, and in particular clear, clearcoats, mouldings, especially optical mouldings, and self-supporting films.

For example the surface coatings are highly scratch-resistant clearcoats, and also highly scratch-resistant clearcoats as part of multicoat color and/or effect paint systems, on customary and known substrates. Such surface coatings are described in the international patent application WO 03/016411, page 41 line 6 to page 43 line 6 in conjunction with page 44 line 6 to page 45 line 6, the content of which is incorporated herein by reference.

The production of the thermoplastic and thermoset materials from the curable materials has no peculiarities in terms of method but is instead carried out with the aid of customary and known processes and apparatus that are typical for the particular thermoplastic or thermoset material.

In particular the coating materials are applied to substrates with the aid of the customary and known processes and apparatus described in international patent application WO 03/016411, page 37 lines 4 to 24, the content of which is incorporated herein by reference.

The curable materials can be cured as described in international patent application WO 03/016411, page 38 line 1 to page 41 line 4, the content of which is incorporated herein by reference.

The curable materials provide thermoplastic and thermoset materials, especially thermoset materials, particularly surface coatings, especially clearcoats, mouldings, especially optical mouldings, and self-supporting films which are of high scratch resistance and chemical stability. In particular the surface coatings, especially the clearcoats, can be produced even in film thicknesses >40 μm without stress cracks appearing.

The thermoplastic and thermoset materials, especially thermoset materials, are therefore outstandingly suitable for use as highly scratch-resistant, decorative, protective and/or effect-imparting surface coatings on bodies of means of transport of any kind (particularly means of transport operated by muscle power, such as cycles, coaches or railway trollies; motorized means of transport, such as aircraft, especially aeroplanes, helicopters or airships; floating structures, such as ships or buoys; rail vehicles, such as locomotives, railcars and railway wagons; and also motor vehicles, such as motorcycles, buses, lorries or cars) or on parts thereof, on the interior and exterior of buildings; on furniture, windows, and doors; on plastic mouldings, especially those of polycarbonate, particularly CDs and windows, especially windows in the automotive sector; on small industrial parts; on coils, containers, and packaging; on white goods; on films; on optical, electrical, and mechanical components; and also on hollow glassware and articles of everyday use.

The surface coatings, especially the clearcoats, can be employed in particular in the especially technologically and aesthetically demanding field of automotive OEM finishing. There they are notable in particular for especially high carwash resistance and scratch resistance, especially dry scratch resistance.

The nanoparticles can also be used as a filler in polymers such as epoxide, polyalkylene terephthalates (PET, PBT) or polyurethanes.

The nanoparticles according to the invention are for example especially suitable in water-based dispersion adhesives. The use of nanoparticles for the preparation of water-based dispersion adhesives is described in the international patent application EP2007/051075, the content of which is incorporated herein by reference.

Preferred adhesive dispersions contain polymers or copolymers selected from the group consisting of polyacrylates, polyurethanes and epoxy resins, and mixtures thereof. Also embraced are corresponding copolymers containing at least 30% by weight acrylate or polyurethanes and including other monomers. Acrylate and polyurethanes can of course be composed of one, two or more kinds of monomers, for example copolymers of methacrylate and butyl acrylate can be employed.

The nanoparticles according to the invention can be incorporated into the water-based dispersion adhesives as a dry powder or as dispersion in water or in an organic solvent. The nanoparticles are preferably added to the water-based dispersion adhesives as a dry powder or as an aqueous dispersion.

The above comments apply particularly to deagglomerated barium sulphate which has been coated with the above-described dispersants.

### EXAMPLE 1

### Preparation of a Copolymer (a)

A steel reactor with a volume of five litres was charged with 1716.9 g of deionized water and this initial charge was heated to 90° C. Subsequently, at this temperature, three separate feed streams, commenced simultaneously, were metered in with stirring, at a uniform rate, over the course of 4 hours (feed 1), 3.75 hours (feed 2), and 4.5 hours (feed 3).

Feed 1 consisted of 477 g of acrylic acid, 75.3 g of 2-(acetoacetoxy)ethyl methacrylate (Lonzamon® AAEMA from Lonza), 199.5 g of methyl methacrylate, 267.3 g of 2-ethylhexyl methacrylate, 113 g of styrene, and 50.1 g of diphenylethylene.

Feed 2 consisted of 46.4 g of 25 percent strength ammonia solution and 232.2 g of deionized water.

Feed 3 was a solution of 75.5 g of ammonium peroxodisulphate in 176 g of water.

The end of the feeds (i.e., the end of feed 3) was followed by a three-hour post-polymerization at 90° C. This gave a yellowish white dispersion of the copolymer (A) with a pH of 4.7 and a solids content of 27% by weight (60 minutes/130° C.).

The dispersion of the copolymer (A) was outstandingly suitable as crystallization inhibitor and dispersant for the preparation of deagglomerated barium sulphate nanoparticles.

### EXAMPLE 2

### Preparation of a Dispersion of Deagglomerated Barium Sulphate Using Citrate as Crystallization Inhibitor

The dispersion prepared as in Example 1 was mixed with barium sulphate precipitated from a sulphuric acid solution (0.4 mol/l) and a barium hydroxide solution (0.4 mol/l), using citric acid as crystallization inhibitor (7.5% by weight of the resulting barium sulphate), to give a preparation containing about 50% by weight water, about 15% by weight of the copolymer (A) from Example 1, and barium sulphate as the remainder to 100% by weight. The preparation was first passed through a dissolver and subsequently comminuted in a ball mill until the particle size d₅₀ was approximately 45 nm. Measurement took place by means of CPS (disc centrifuge).

This gave a stable dispersion which lent itself very well to incorporation into polymer materials.

### EXAMPLE 3

### Preparation of a Dispersion of Deagglomerated Barium Sulphate Using Na Polyacrylate as Crystallization Inhibitor

The dispersion prepared as in Example 1 was mixed with barium sulphate precipitated from a sulphuric acid solution (0.4 mo/l) and a barium hydroxide solution (0.4 mol/l), using sodium polyacrylate (3% Dispex® N40, based on the weight of the resulting barium sulphate) as crystallization inhibitor, to give, as in Example 2, a preparation containing about 50% by weight water, about 15% by weight of the polymer from Example 1, and barium sulphate as the remainder to 100% by weight. The preparation was first passed through a dissolver and subsequently comminuted in a ball mill until the particle size d₅₀ was again approximately 45 nm. Measurement took place by means of CPS (disc centrifuge).

With this barium sulphate product as well, this gave a stable dispersion which lent itself very well to incorporation into polymer materials.

### EXAMPLE 4

### Preparation of a Dispersion of Deagglomerated Barium Sulphate Without Na Polyacrylate as Crystallization Inhibitor

The dispersion prepared as in Example 1 was mixed with barium sulphate precipitated without crystallization inhibitor, to give, as in Examples 2 and 3, a preparation containing about 50% by weight water, about 15% by weight of the polymer from Example 1, and barium sulphate as the remainder to 100% by weight. The preparation was first passed through a dissolver and subsequently comminuted in a ball mill until the particle size d₅₀ was again approximately 45 nm. Measurement took place by means of CPS (disc centrifuge).

With this barium sulphate product as well, this gave a stable dispersion which lent itself very well to incorporation into polymer materials.

### EXAMPLE 5

### Use of the Deagglomerated Barium Sulphate According to Example 3 in Dispersion Adhesives Based on Polyurethane

5.1 With deagglomerated barium sulphate prepared according to Example 3 (containing sodium polyacrylate as crystallization inhibitor and the Copolymer (A) of Example 1 as dispersant 190 g of a polyurethane dispersion in water (BASF Luphen DS 3548, a PU polyester) were admixed dropwise and with vigorous stirring to 20 g of the barium sulphate dispersion (50% by weight solids content) prepared according to Example 3. The dispersion was further mixed under gentle agitation for around 5 more minutes. The dispersion was then passed through a 120 μm filter sieve and degassed under reduced pressure and by means of ultrasound. The degassed sample was then transferred to a silicone mould, placed in a heating cabinet and, without being moved, was converted at 30° C. into an adhesive film.

At room temperature the films were hard and opaque, since they were crystalline. At 30 to 40° C. they passed into the amorphous state, became clear, and softened. The barium sulphate was present in the films in an amount of 10% by weight.

5.2 Reference Film (Comparative Example)

Example 5.1. was repeated, but without incorporation of barium sulphate. The film formed was used as the reference film.

PU dispersions were used as what are called heat-sealing systems. They softened at 80° C. and in so doing developed a tack; at room temperature, in contrast, they were solid and non-tacky. The problem was their deficient temperature stability. Improved cohesion and improved thermal stability are particularly important in these systems.

5.3 Mechanical Investigation of the Films Produced

5.3.1 Investigation of Tensile Strength/Breaking Elongation:

The investigation was carried out using an instrument from Zwick/Roell. Measurements were performed fundamentally in triplicate. The dumbbell specimens were produced from the films by punching. Before the tensile strength/breaking extension investigation, the films were preheated in an oven at 80° C. for 20 minutes and then taken individually from the oven for each measurement and clamped into the jaws of the investigation instrument. After exactly 60 seconds the measurement was commenced. At that point the films were still in the amorphous state.

The reference film broke at a lengthwise extension of 700%; the strain on breaking was 1.5 N/mm². The adhesive film of the invention (ex. 5.1) did not break even at a lengthwise extension of 800% of the original length, which amounted to the end of the measurement distance. Its strain for a lengthwise extension of 800% was around 11 N/mm².

5.3.2 Dynamomechanical Analysis:

The dynamomechanical analysis (DMA) was carried out in an instrument from Bohlin (model CVO 120). The complex shear modulus G was determined by shearing a sample between two parallel plates, in the course of which the polymer film to be analysed was placed between two aluminium discs and sheared at constant frequency and increasing temperature (oscillation). DMA measurements were carried out. The temperature range selected was −20° C. to 200° C. Cooling was carried out with liquid nitrogen.

Reference sample: A sharp drop was apparent in the storage modulus G′ as a function of the temperature. Thus 10⁴ Pa were crossed at 120° C. The film softened sharply above 100° C. and was virtually liquid at 200° C.

Adhesive film with 10% by weight modified barium sulphate (ex. 5.1): with the storage modulus G′ measurement, a figure of 10⁴ Pa was crossed only at 177° C. There is therefore a markedly improved thermal stability, which is of great advantage for heat-sealing systems.

5.4 Use of Different PU Dispersions

Example 5.1 was repeated, but using Luphen D 207 and Luphen DS 3528 as polyurethane dispersions, the modified barium sulphate being present in an amount of 20% by weight in the films. These are likewise aqueous, resin-modified, anionic, emulsifier-free emulsions of polyester-PU elastomers. As Luphen DS 3548, Luphen D 207 and DS 3628 have particle diameters of 200 nm. They are used for producing laminating adhesives, contact adhesives and foam adhesives.

According to those two examples, the modified barium sulphate was present in the films in an amount of 20% by weight: 180 g of a polyurethane dispersion in water (BASF Luphen D 207 or DS 3528) were added to 40 g of the barium sulphate dispersion (50% by weight solids content) prepared according to Example 3.

Here as well, there was a distinct improvement in properties as compared with the adhesive film free of barium sulphate. From 11 N/mm² in the case of the reference film of Luphen D 207, the force rose to 16 N/mm² in the case of the sample containing barium sulphate. In the case of DS 3258 an increase from 12 to 16 N/mm² was observed.

1. Particles coated with a dispersant in the form of copolymers (A) of olefinically unsaturated monomers (a), preparable by single-stage or multistage controlled free-radical copolymerization in an aqueous medium of
(a1) at least one olefinically unsaturated monomer containing at least one chelate-forming group and
(a2) at least one olefinically unsaturated monomer different from olefinically unsaturated monomer (a1) and selected from the group consisting of
(a21) monomers of the general formula
R¹R²C═CR³R⁴ (I),
in which the radicals R¹, R², R³, and R⁴ each independently are hydrogen atoms or substituted or unsubstituted alkyl cycloalkyl, alkylcycloalkyl, cycloalkylalkyl, aryl, alkylaryl, cycloalkylaryl, arylalkyl or arylcycloalkyl radicals, with the proviso that at least two of the variables R¹, R², R³, and R⁴ are substituted or unsubstituted aryl, arylalkyl or arylcycloalkyl radicals, especially substituted or unsubstituted aryl radicals,
(a22) olefinically unsaturated terpene hydrocarbons, and
(a23) dimeric alpha-alkylvinylaromatics.

2. The particles according to claim 1, wherein said particles are nanoparticles having a primary particle size of less than or equal to 500 nm, preferably of less than or equal to 400 nm, more preferably less than or equal to 100 nm, with particular preference less than or equal to 50 nm.

3. The particles according to claim 1, wherein the at least one chelate-forming group of the monomer (a1) is at least bidentate.

4. (canceled)

5. The particles according to claim 3, wherein the atomic groupings are selected from the group consisting of carbonyl groups (>C═O), thiocarbonyl groups (>C═S), ether groups (—CH₂—O—CH₂—), thioether groups (—CH₂—S—CH₂—), primary, secondary, and tertiary amino groups (≧C—NR⁵₂) with R⁵=hydrogen atom or alkyl radical having 1 to 6 carbon atoms, primary and secondary imino groups (>C═NR⁵) with R⁵=hydrogen atom or alkyl radical having 1 to 6 carbon atoms, oxime groups (>C═N—O—H), imino ether groups (>C═N—O—R⁶) with R⁶=alkyl radical having 1 to 10 carbon atoms or cycloalkyl radical having 4 to 10 carbon atoms, and also primary, secondary, and tertiary phosphine groups (—PR⁷₂) with R⁷=hydrogen atom or alkyl radical having 1 to 6 carbon atoms, cycloalkyl radical having 4 to 10 carbon atoms or aryl radical having 6 to 10 carbon atoms.

6. (canceled)

7. The particles according to claim 5, wherein the chelate-forming groups are 1,3-dicarbonyl groups.

8. The particles according to claim 1, wherein the olefinically unsaturated groups of the monomers (a1) are selected from the group consisting of (meth)acrylate, ethacrylate, crotonate, cinnamate, vinyl ether, vinyl ester, dicyclopentadienyl, norbornenyl, isoprenyl, isopropenyl, allyl or butenyl groups, dicyclopentadienyl ether, norbornenyl ether, isoprenyl ether, isopropenyl ether, allyl ether or butenyl ether groups, or dicyclopentadienyl ester, norbornenyl ester, isoprenyl ester, isopropenyl ester, allyl ester or butenyl ester groups.

9. (canceled)

10. The particles according to claim 8, wherein in a monomer (at) the chelate-forming group(s) is or are attached to the olefinically unsaturated group(s) via at least one covalent bond or via at least one divalent linking group.

11-12. (canceled)

13. The particles according to claim 1, wherein the aryl radicals R¹, R², R³ and/or R⁴ of the monomers (a21) are phenyl or naphthyl radicals.

14-15. (canceled)

16. The particles according to claim 1, wherein the substituents in the radicals R¹, R², R³ and/or R⁴ of the monomers (a21) are selected from the group consisting of halogen atoms, nitrile radicals, nitro radicals, partially or fully halogenated alkyl, cycloalkyl, alkylcycloalkyl, cycloalkylalkyl, aryl, alkylaryl, cycloalkylaryl, arylalkyl and arylcycloalkyl radicals; aryloxy, alkyloxy, and cycloalkyloxy radicals; arylthio, alkylthio, and cycloalkylthio radicals; hydroxyl groups; and primary, secondary, and tertiary amino groups.

17. The particles according to claim 1, wherein the terpene hydrocarbon (a22) is selected from the group consisting of acyclic terpenes, monocyclic terpenes, bicyclic terpenes, acyclic sesquiterpenes, monocyclic sesquiterpenes, bicyclic sesquiterpenes, tricyclic sesquiterpenes, acyclic diterpenes, monocyclic diterpenes, and tricyclic diterpenes.

18. (canceled)

19. The particles according to claim 10, wherein the terpene hydrocarbon (a22) is selected from the group consisting of ocimene, myrcene, the menthenes, the menthadienes, alpha-pinene, and beta-pinene.

20-21. (canceled)

22. The particles according to claim 1, wherein the dimeric alpha-alkylvinylaromatics (a23) are dimeric alpha-alkylstyrenes.

23. (canceled)

24. The particles according to claim 1, wherein the olefinically unsaturated monomers (a1) and (a2) are copolymerized with at least one different olefinically unsaturated monomer (a3).

25. The particles according to claim 1, wherein said particles are barium sulphate particles.

26. The particles according to claim 1, wherein at least 90% of all the particles which are agglomerated secondary particles and unagglomerated primary particles have a size of less than or equal to 500 nm.

27. The particles according to claim 25, wherein the barium sulphate comprises a crystallization inhibitor added during precipitation.

28. A process for preparing particles coated with a dispersant, according to claim 1, wherein the starting material to be coated is subjected together with the dispersant to a comminution process, the dispersant being obtainable by subjecting at least
(a1) at least one olefinically unsaturated monomer containing at least one chelate-forming group and
(a2) at least one olefinically unsaturated monomer different from olefinically unsaturated monomer (a1) and selected from the group consisting of
(a21) monomers of the general formula I
R¹R²C═CR³R⁴ (I),
in which the radicals R¹, R², R³, and R⁴ each independently are hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of the variables R¹, R², R³, and R⁴ are substituted or unsubstituted aryl, arylalkyl or arylcycloalkyl radicals, especially substituted or unsubstituted aryl radicals,
(a22) olefinically unsaturated terpene hydrocarbons, and
(a23) dimeric alpha-alkylvinylaromatics
to controlled free-radical copolymerization in an aqueous medium.

29. The process according to claim 28, characterized in wherein coating is carried out first in a dissolver and then in a ball mill until particles coated with the dispersant have formed.

30. The process according to claim 28, wherein an aqueous dispersion of the material and of the dispersant is comminuted.

31. (canceled)

32. The process according to claim 28, wherein any solvent is separated off and particles coated with dispersant are obtained in the form of a redispersible, deagglomerated solid.

33. (canceled)

35. A method of use of the particles according to claim 1 as an additive in polymers or in adhesives.

36. (canceled)
